(19) United States
(12) Patent Application Publication
(10) Pub. No.: US 2017/0159651 A1
(43) Pub. Date: Jun. 8, 2017

(54) QUICK INFLATION SYSTEM FOR AIR MATTRESS

(71) Applicant: CAREMED SUPPLY INC., New Taipei City (TW)

(72) Inventor: Pao Ming SHIH, Taipei City (TW)

(73) Assignee: CAREMED SUPPLY INC., New Taipei City (TW)

(21) Appl. No.: 15/079,103

(22) Filed: Mar. 24, 2016

(30) Foreign Application Priority Data
Dec. 3, 2015 (TW) 104219462

(51) Int. Cl. F04B 49/08; A61H 9/00; F04B 49/22; A47C 27/08; F04B 49/00

(52) U.S. Cl. CPC F04B 49/08; A47C 27/082; F04B 49/007; F04B 49/22; A61H 9/0078

(57) ABSTRACT

A quick inflation system for air mattress includes first and second air supply sources connected to air delivery lines and quick air charging lines, respectively. The air delivery lines are further connected to first inflatable portions of an air mattress and respectively have a connecting line led to air input lines connected to second inflatable portions of the air mattress. The quick air charging lines are further connected to the air delivery lines. With these arrangements, once the first and second air supply sources start supplying air, the first and second inflatable portions of the air mattress can quickly change from a non-expanded state into an expanded state. Thereafter, the first air supply source is fluidly connected to different ones of the air delivery lines in a specific sequence; so that there are always some of the first inflatable portions that continuously change between the non-expanded and the expanded state.

### FIELD OF THE INVENTION

The present invention relates to an inflation system, and more particularly, to a quick inflation system that has two air supply sources fluidly connected to a plurality of specially arranged air conveying lines, which are further connected to an air mattress, so as to enable quick inflation of the air mattress.

### BACKGROUND OF THE INVENTION

A patient having difficulty walking or after surgery is often confined to bed. Lying on bed for a long time tends to cause reduced blood flow and accordingly poor blood circulation. In this case, the formation of thrombus, edema, and deep vein thrombosis may occur at the patient's limbs that are distant from the heart. In some worse cases, tissue necrosis will occur at the patient's limbs.

To help the bedridden patient to overcome the above problems, the medical instrument industry has researched and developed an air mattress that can be inflated and deflated intermittently. During the course of intermittent inflation and deflation thereof, the air mattress produces a massage effect and gives passive exercise to the patient's muscles, which will improve the patient's blood circulation. However, a relatively long time is needed to fully inflate this type of air mattress for it to change from a non-expanded state into an expanded state. Therefore, the intermittently inflatable and deflatable air mattress is not so practical for use.

In view of the disadvantage of the intermittently inflatable and deflatable air mattress that requires a lot of time to be fully inflated, it is desirable to develop a quick inflation system for air mattress that can largely reduce the time needed to inflate an air mattress.

### SUMMARY OF THE INVENTION

A primary object of the present invention is to provide a quick inflation system for air mattress, in which two air supply sources are included to work with a plurality of specially arranged air conveying lines, so that air supplied by the two air supply sources can flow through the air conveying lines into an air mattress to quickly inflate the same.

To achieve the above and other objects, the quick inflation system for air mattress according to the present invention is used with an air mattress. The air mattress includes a plurality of intermittently inflated and deflated first inflatable portions and at least one continuously inflated second inflatable portion. The quick inflation system for air mattress includes a first air supply source, a second air supply source, a plurality of air delivery lines, a plurality of quick air charging lines, and at least one air input line.

The first air supply source has a first control valve, and the second air supply source has a second control valve. The air delivery lines respectively have a first coupling section and a second coupling section located at two opposite ends thereof. All the first coupling sections are connected to the first control valve, and the second coupling sections are respectively connected to one of the quick air charging lines. Further, the air delivery lines are respectively connected to one of the first inflatable portions, and respectively have a connecting line, on which a first air check unit is provided.

The quick air charging lines are connected at respective one end to the second control valve and at another end to one of the air delivery lines, and respectively have a second air check unit provided thereon. Further, the at least one air input line is simultaneously connected to all the connecting lines and the second inflatable portion of the air mattress.

In an embodiment of the present invention, the at least one air input line is simultaneously connected to all the connecting lines, the second inflatable portion of the air mattress, and the first control valve of the first air supply source. However, according to another embodiment, the air input line can be connected to the first air supply source via a third control valve.

The first air supply source can, through control of the first control valve, be selectively blocked from some of the air delivery lines or fluidly connected to all the air delivery lines; and the second air supply source can, through control of the second control valve, be selectively blocked from all the quick air charging lines or fluidly connected to each of the quick air charging lines.

Further, the first air supply source and the second air supply source are respectively fluidly connected to the air delivery lines and the quick air charging lines through control of the first control valve and the second control valve, respectively. A part of the air supplied from the first air supply source to the air delivery lines directly flows into the first inflatable portions of the air mattress for the first inflatable portions to change from a first non-expanded state, in which the first inflatable portions are not fully inflated, into a first expanded state, in which the first inflatable portions are fully inflated, and the other part of the supplied air flows through the connecting lines into the air input line for the second inflatable portion of the air mattress to change from a second non-expanded state, in which the second inflatable portion is not fully inflated, into a second expanded state, in which the second inflatable portion is fully inflated. According to a preferred embodiment, with the first air check units, air in the connecting lines can flow in only one direction from the air delivery line to the air input line, so that the second inflatable portion of the air mattress can continuously maintain the second expanded state even if the first air supply source is fluidly connected to different ones of the air delivery lines in a specific sequence. Similarly, with the second air check units, air in the quick air charging lines can flow in only one direction from the quick air charging lines to the air delivery lines.

The second air supply source supplies air to the quick air charging lines, and the supplied air also flows into the air delivery lines to quicken the change of the first inflatable portions of the air mattress from the first non-expanded state into the first expanded state.

According to a preferred embodiment, when all the first inflatable portions have changed into the first expanded state, the second air supply source is, through control of the second control valve, blocked from all the quick air charging lines, and the first air supply source is, through control of the first control valve, fluidly connected to only a part of the air delivery lines, bringing some of the first inflatable portions to change between the first non-expanded state and the first expanded state.

According to another preferred embodiment, when all the first inflatable portions have changed into the first expanded state, the second air supply source is, through control of the second control valve, blocked from all the quick air charging lines, and the first air supply source is, through control of the first control valve, fluidly connected to different ones of the air delivery lines in a specific sequence, so that some of the first inflatable portions change from the first non-expanded state into the first expanded state, while others change from the first expanded state into the first non-expanded state.

In brief, the quick inflation system for air mattress according to the present invention is characterized in having a first and a second air supply source as well as a plurality of air delivery lines, quick air charging lines and air input lines that are specially arranged and connected to one another, so that air supplied from the first and the second air supply source can flow into the air delivery lines from two opposite ends thereof, enabling the first and the second inflatable portions of the air mattress to more quickly change from the non-expanded state into the expanded state. Moreover, when all the first inflatable portions have changed into the expanded state, the second air supply source is, through control of the second control valve, blocked from all the quick air charging lines, and the first air supply source is, through control of the first control valve, fluidly connected to different ones of the air delivery lines in a specific sequence, so that there are always some of the first inflatable portions that continuously change between the first non-expanded state and the first expanded state. And, during the course of the change of the first inflatable portions between the non-expanded state and the expanded state, the first inflatable portions of the air mattress can produce a massage effect and give passive exercise to the muscles of the patient lying on the air mattress to improve the patient's blood circulation.

Further, with the first air check units that allow the supplied air to flow in only one direction from the air delivery lines to the air input lines, the second inflatable portions of the air mattress can continuously maintain the second expanded state even if the first air supply source is fluidly connected to different ones of the air delivery lines in a specific sequence.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view showing the use of a quick inflation system for air mattress according to a first embodiment of the present invention with an air mattress;

FIG. 2 is a perspective view of an air delivery control unit of the quick inflation system for air mattress according to the first embodiment of the present invention;

FIG. 3 is a perspective view showing internal arrangements of the air delivery control unit of FIG. 2;

FIG. 4 is a fragmentary perspective view showing the delivery of air from a first air supply source in the air delivery control unit into a plurality of air delivery lines and air input lines of the quick inflation system for air mattress;

FIG. 5 is a fragmentary perspective view showing the delivery of air from a second air supply source in the air delivery control unit into a plurality of quick charging lines of the quick inflation system for air mattress;

FIG. 6 is an assembled perspective view showing a first manner in which the quick inflation system of the present invention inflates the air mattress intermittently;

FIG. 7 is a fragmentary perspective view showing a second manner in which the quick inflation system of the present invention inflates the air mattress intermittently;

FIG. 8 is a perspective view of the air delivery control unit according to a second embodiment of the present invention;

FIG. 9 is a block diagram showing the air input lines are connected to the first air supply source via a third control valve; and

FIG. 10 is a block diagram showing the air input lines are connected to the first air supply source via a first control valve.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

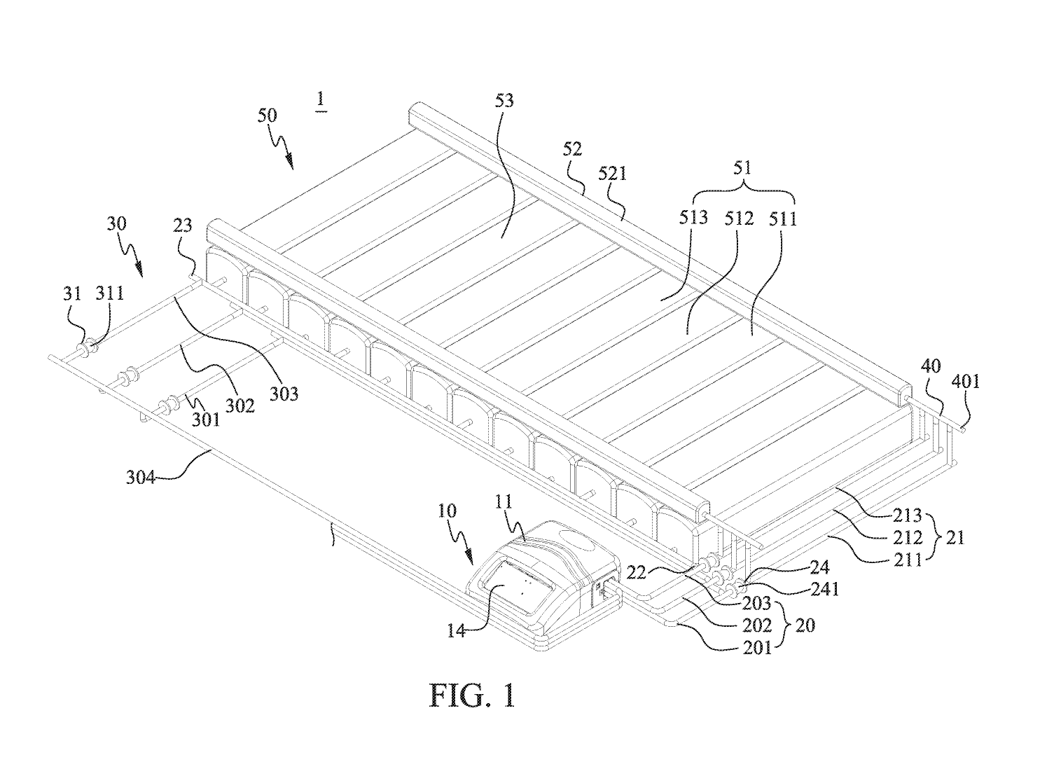

Please refer to FIG. 1, which is an assembled perspective view a quick inflation system for air mattress according to a first embodiment of the present invention is used with an air mattress 50. For the purpose of conciseness, the present invention is also briefly referred to as the quick inflation system and generally denoted by reference number 1 herein. The air mattress 50 includes a plurality of first inflatable portions 51 and at least one second inflatable portion 52 located on the first inflatable portions 51. In the illustrated first embodiment, the first inflatable portions 51 of the air mattress 50 include four pieces of first support air cells 511, four pieces of second support air cells 512, and four pieces of third support air cells 513. The first support air cells 511, second support air cells 512 and third support air cells 513 are arranged side-by-side and connected to one another in a specific sequence, such that each of the first support air cells 511 is followed by one piece of the second support air cell 512 and one piece of the third support air cell 513.

The second inflatable portion 52 of the air mattress 50 includes two handrail air cells 521. The handrail air cells 521 and the first, second and third support air cells 511, 512, 513 together define a lying space 53, in which a patient can comfortably and safely lie on the air mattress 50.

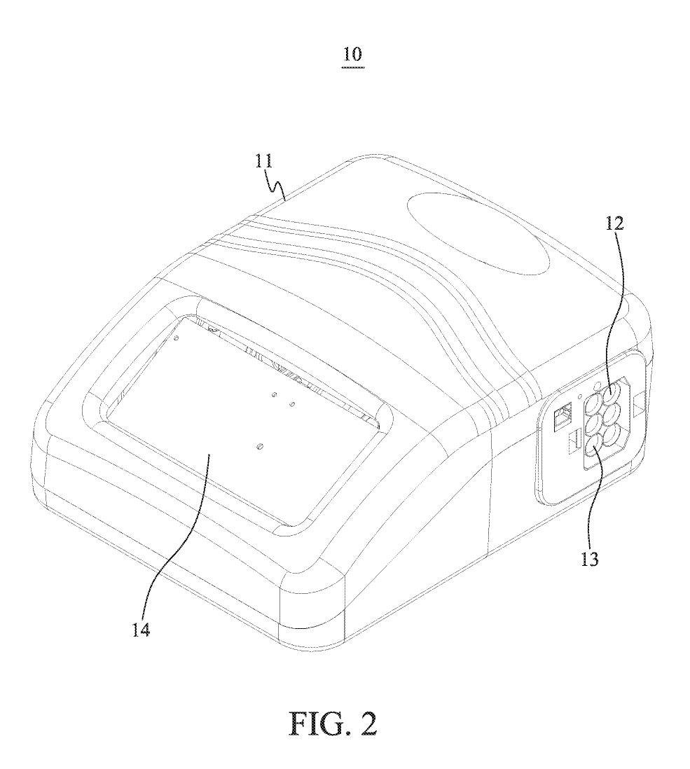

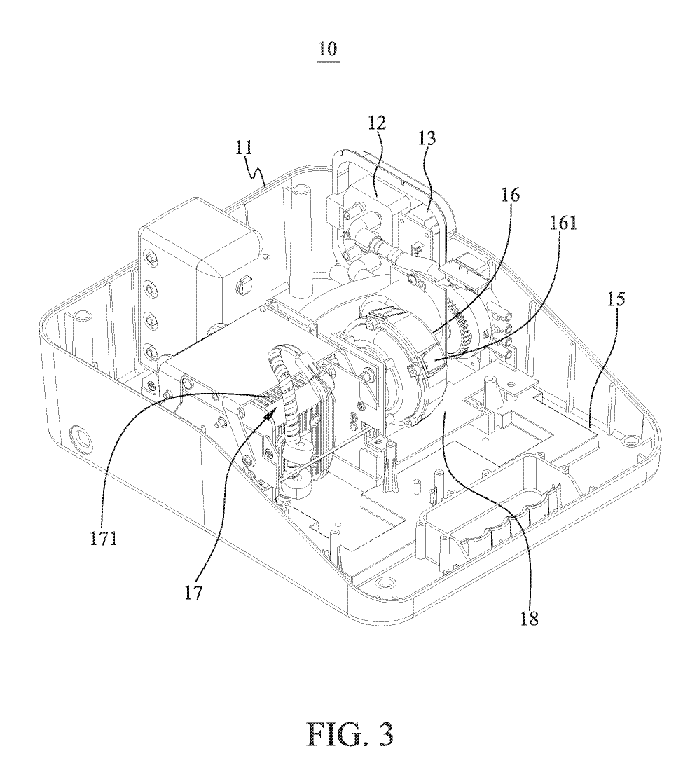

Please refer to FIGS. 2 and 3. The quick inflation system 1 includes an air delivery control unit 10, a plurality of air delivery lines 20, a plurality of quick air charging lines 30, and at least one air input line 40. The air delivery control unit 10 has a housing 11, on which a first control valve 12, a second control valve 13 and an operating panel 14 are provided. The housing 11 also internally defines a receiving space 15, in which a first air supply source 16, a second air supply source 17 and a circuit board 18 are mounted. The first air supply source 16, the second air supply source 17 and the operating panel 15 are electrically connected to the circuit board 18. In the illustrated first embodiment, the first air supply source 16 is an air blower 161, and the second air supply source 17 is an air pump 171.

As can be seen in FIG. 1, the air delivery lines 20 are respectively connected to one of the first inflatable portions 51. Each of the air delivery lines 20 has a connecting line 21 extended therefrom, and a first air check unit 24 is provided on each of the connecting lines 21. And, a first coupling section 22 and a second coupling section 23 are located at two opposite ends of the air delivery line 20. The first coupling sections 22 of all the air delivery lines 20 are connected to the first control valve 12. In the illustrated first embodiment, the air delivery lines 20 include a first air delivery line 201, a second air delivery line 202 and a third air delivery line 203, which respectively have a first connecting line 211, a second connecting line 212 and a third connecting line 213. The first, second and third air delivery lines 201, 202, 203 are respectively connected to the four pieces of first support air cells 511, the four pieces of second support air cells 512 and the four pieces of third support air cells 513. The first connecting line 211, the second connecting line 212 and the third connecting line 213 respectively have a first air check valve 241 provided thereon; and the three pieces of first air check valves 241 form the above-mentioned first air check units 24.

Also as shown in FIG. 1, the quick air charging lines 30 are connected at respective one end to the second control valve 13 on the air delivery control unit 10, and at another end to one of the second coupling sections 23 of the air delivery lines 20. That is, the air delivery lines 20 are respectively connected at two opposite ends to the first air supply source 16 in the air delivery control unit 10 and one of the quick air charging lines 30. Each of the quick air charging lines 30 is provided with a second air check unit 31. In the illustrated first embodiment, the quick air charging lines 30 include a first quick air charging line 301, a second quick air charging line 302, a third quick air charging line 303, and a coupling line 304. The first, second and third quick air charging lines 301, 302, 303 are respectively connected at an end to the first, the second and the third air delivery line 201, 202, 203; and the coupling line 304 has an end connected to the second control valve 13 on the air delivery control unit 10 and another end coupled to the first, second and third quick air charging lines 301, 302, 303. Further, the first, second and third quick air charging lines 301, 302, 303 respectively have a second air check valve 311 provided thereon, and the three pieces of second air check valves 311 form the above-mentioned second air check units 31.

The air input line 40 is simultaneously connected to the connecting lines 21 and the second inflatable portion 52 of the air mattress 50. In the illustrated first embodiment, there are two air input lines 40, each of which includes a length of first air input lines 401. The first air input lines 401 respectively have an end connected to the first, second and third connecting lines 211, 212, 213 and another end connected to one of the two handrail air cells 521.

However, it is understood the above description of the air input line 40 formed of a length of first air inlet line 401 is only illustrative and not intended to limit the present invention in any way. For example, in another embodiment, each of the air input lines 40 can be formed of a first air input line 401, a second air input line (not shown) and a third air input line (not shown).

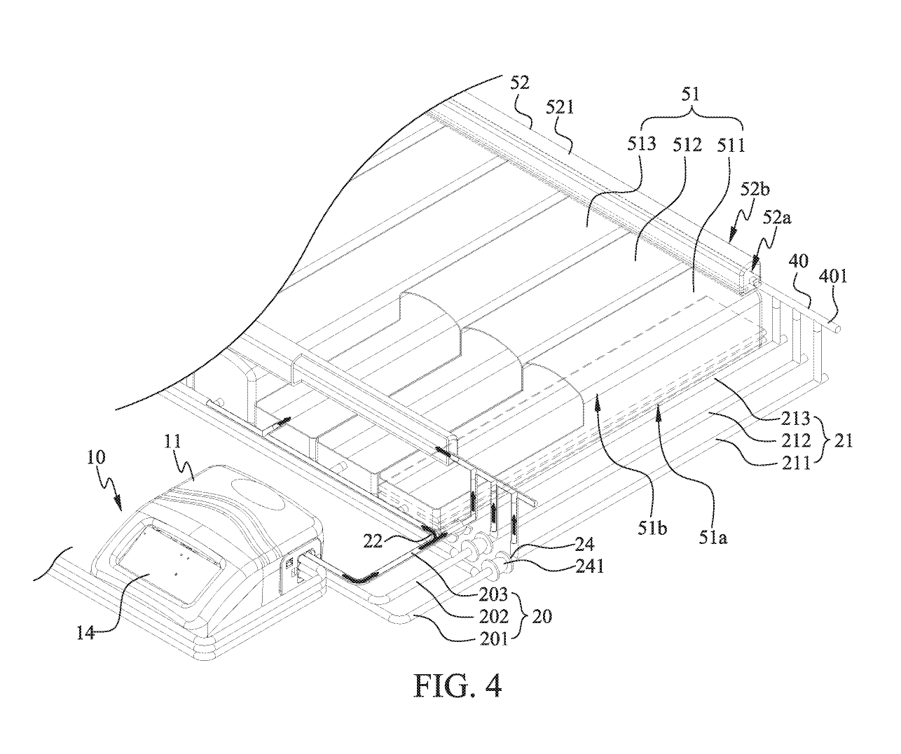

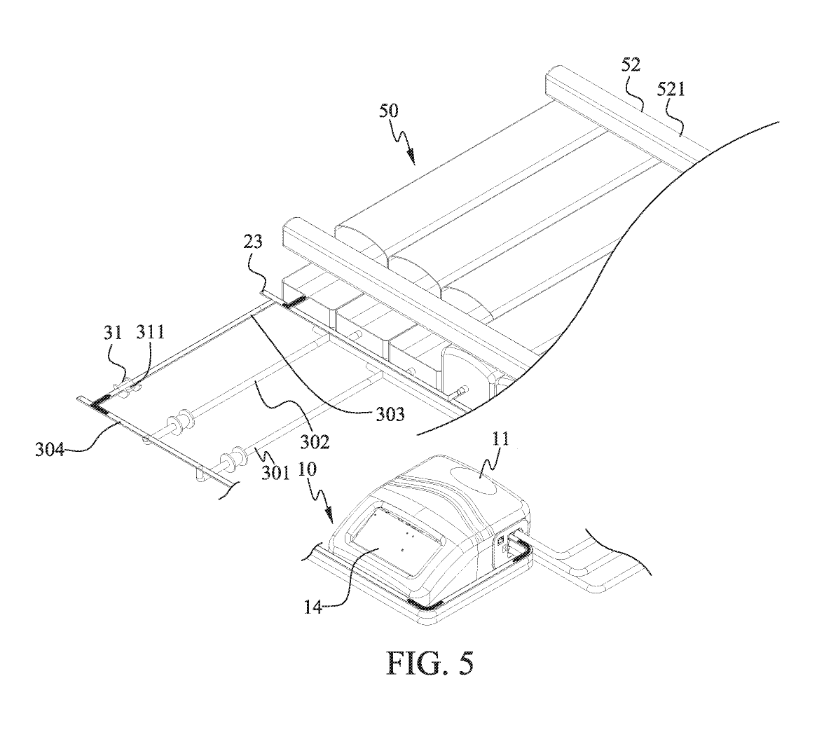

Please refer to FIGS. 4 and 5. In practical use of the quick inflation system 1, the first air supply source 16 is fluidly connected to each of the air delivery lines 20 through control of the first control valve 12, so that air supplied by the first air supply source 16 is delivered into the air delivery lines 20 via the first coupling sections 22; and similarly, the second air supply source 17 is fluidly connected to each of the quick air charging lines 30 through control of the second control valve 13, so that air supplied by the second air supply source 17 is delivered to all the quick air charging lines 30. At this point, with the second air check units 31, air can flow in only one direction from the quick air charging lines 30 to the second coupling sections 23 of the air delivery lines 20. With these arrangements, air can be delivered into the first inflatable portions 51 from two opposite ends of the air delivery lines 20, so that the first inflatable portions 51 of the air mattress 50 can more quickly change from a first non-expanded state 51a, in which the first inflatable portions 51 are not filled with air, to a first expanded state 51b, in which the first inflatable portions 51 are fully filled with air.

When the first air supply source 16 in the air delivery control unit 10 supplies air for delivering into the first inflatable portions 51 via the first coupling sections 22, a part of the supplied air flows to the air input lines 40 via the connecting lines 21, allowing the second inflatable portion 52 of the air mattress 50 to change from a second non-expanded state 52a, in which the second inflatable portion 52 is not filled with air, to a second expanded state 52b, in which the second inflatable portion 52 is fully filled with air. Further, since the connecting lines 21 are respectively provided with the first air check unit 24, air supplied by the first air supply source 16 can flow in only one direction from the air delivery lines 20 toward the air input lines 40 but not from the air input lines 40 toward the air delivery lines 20.

When all the first inflatable portions 51 of the air mattress 50 have changed into the first expanded state 51b, the second air supply source 17 in the air delivery control unit 10 is, through control of the second control valve 13, blocked from all the quick air charging lines 30, so that air is no longer supplied from the second air supply source 17 into the quick air charging lines 30. At this point, the second air check units 31 function to stop air from flowing from the air delivery lines 20 back into the quick air charging lines 30.

As shown, in the illustrated first embodiment, an operator (not shown) can operate on the operating panel 14 to open the first control valve 12 and the second control valve 13. At this point, the first air supply source 16 is fluidly connected to the first, second and third air delivery lines 201, 202, 203, and the second air supply source 17 is fluidly connected to the first, second and third quick air charging lines 301, 302, 303.

Then, the operator operates on the operating panel 14 to generate a start signal to the circuit board 18, which in turn transmits the start signal to the air blower 161 and the air pump 171. After receiving the start signal, the air blower 161 starts supplying air to the first, second and third air delivery lines 201, 202, 203 at the same time to inflate the first, second and third support air cells 511, 512, 513, bringing these support air cells to change from the first non-expanded state 51a into the first expanded state 51b.

A part of the air supplied by the air blower 161 to the first, second and third air delivery lines 201, 202, 203 flows through the first, second and third connecting lines 211, 212, 213 into the first air input lines 401 to inflate the two handrail air cells 521, bringing them to change from the second non-expanded state 52a into the second expanded state 52b.

Meanwhile, after receiving the start signal, the air pump 171 starts supplying air to the first, second and third quick air charging lines 301, 302, 303 at the same time, so that air also flows into the first, second and third air delivery lines 201, 202, 203 via the second coupling sections 23. In this manner, the time for the first, second and third support air cells 511, 512, 513 to change from the first non-expanded state 51a into the first expanded state 51b can be shortened.

When all the first, second and third support air cells 511, 512, 513 have changed into the first expanded state 51b, the circuit board 18 will generate a block signal to the second control valve 13, so that the second control valve 13 blocks the air pump 171 from being fluidly connected to the first, second and third quick air charging lines 301, 302, 303, and air is no longer delivered from the air pump 171 to the first, second and third quick air charging lines 301, 302, 303. At this point, the second air check valves 311 on the first, second and third quick air charging lines 301, 302, 303 function to stop air from flowing from the first, second and third air delivery lines 201, 202, 203 back into the first, second and third quick air charging lines 301, 302, 303.

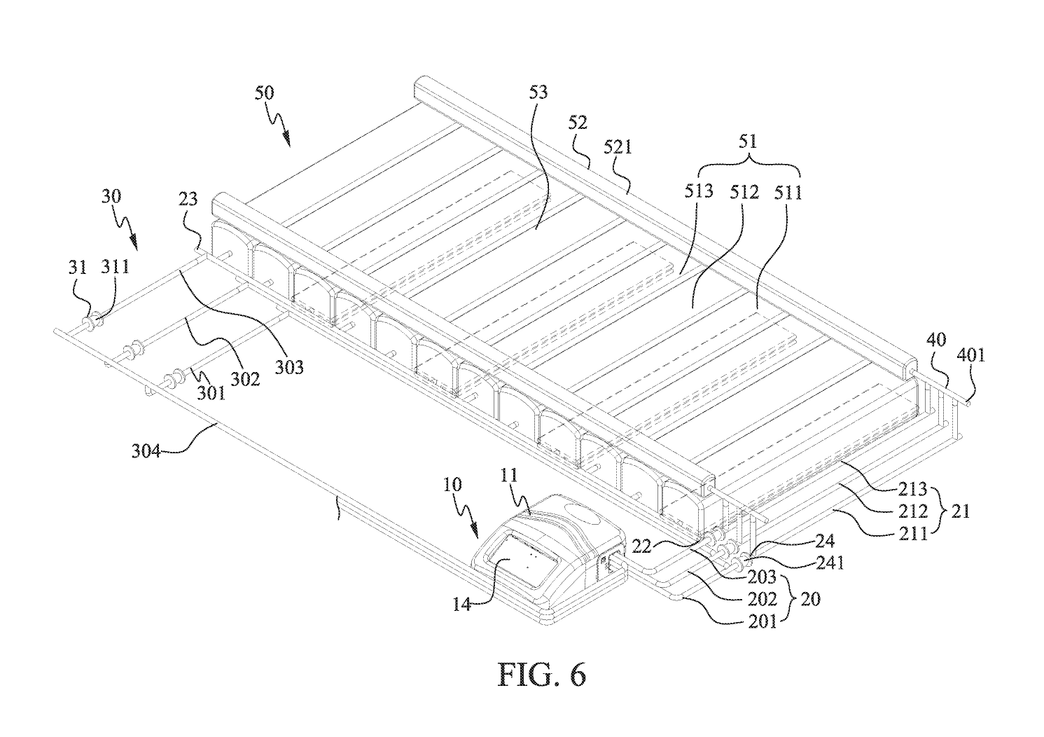

Please refer to FIG. 6. When all the first inflatable portions 51 of the air mattress 50 have changed into the first expanded state 51b, the first air supply source 16 in the air delivery control unit 10 is, through control of the first control valve 12, fluidly connected to only a part of the air delivery lines 20 and follows a signal from the circuit board 18 to start intermittent supply of air to the currently fluidly connected air delivery lines 20, so that some of the first inflatable portions 51 are brought to continuously change between the first non-expanded state 51a and the first expanded state 51b and accordingly, massage the patient lying in the lying space 53 of the air mattress 50 to improve the patient's blood circulation.

During the course of intermittent supply of air from the first air supply source 16 to the air delivery lines 20, the first control valve 12 closes only some of the air delivery lines 20 while other air delivery lines 20 are still fluidly connected to the first air supply source 16. Therefore, the supplied air can still flow through a part of the connecting lines 21 to the air input lines 40, enabling the second inflatable portions 52 of the air mattress 50 to continuously maintain the second expanded state 52b.

In the illustrated first embodiment, via the circuit board 18, the operator can first specify the first control valve 12 to block the fluid connection between the air blower 161 and the first air delivery line 201, so that the air blower 161 stops supplying air to the first air delivery line 201 while keeps supplying air to the second and third air delivery lines 202, 203. At this point, the four pieces of first support air cells 511 start releasing air and change from the first expanded state 51b into the first non-expanded state 51a. Since the air blower 161 still supplies air to the second and third air delivery lines 202. 203, a part of the supplied air will flow through the second and third connecting lines 212, 213 to the first air input lines 401, enabling the two handrail air cells 521 to continuously maintain the second expanded state 52b.

When the first support air cells 511 have changed into the first non-expanded state 51a, the circuit board 18 will instruct the air blower 161 to inflate the first support air cells 511, so that the first support air cells 511 can change into the first expanded state 51b again. Thereafter, via the circuit board 18, the operator can instruct the first control valve 12 to sequentially close the second air delivery line 202 and the third air delivery line 203, so that the air blower 161 sequentially stops supplying or supplies air to the second and the third air delivery line 202, 203. With these arrangements, the first, the second and the third support air cells 511, 512, 513 can sequentially change between the first non-expanded state 51a and the first expanded state 51b to generate a massage effect on the patient lying in the lying space 53 of the air mattress 50, so as to improve the patient's blood circulation.

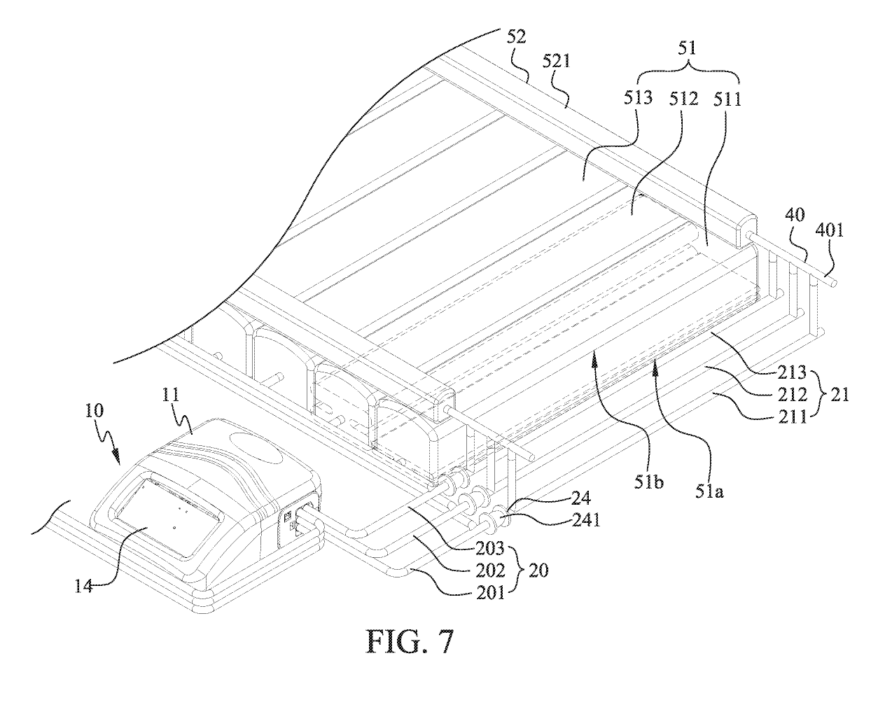

However, it is understood the above description of the intermittent supply of air from the first air supply source 16 to different first inflatable portions 51 through control of the first control valve 12 in order for different ones of the first inflatable portions 51 to change between the first non-expanded state 51a and the first expanded state 51b in a specific sequence is only illustrative and not intended to limit the present invention in any way. For instance, as shown in FIG. 7, when all the first inflatable portions 51 have changed into the first expanded state 51b, the second air supply source 17 can also be blocked from all the quick air charging lines 30 through control of the second control valve 13 and stops supplying air to the quick air charging lines 30.

Thereafter, through control of the first control valve 12, the first air supply source 16 is fluidly connected to different ones of the air delivery lines 20 in a specific sequence, so that some of the first inflatable portions 51 are changed from the first non-expanded state 51a into the first expanded state 51b while others are changed from the first expanded state 51b into the first non-expanded state 51a. With these arrangements, the first inflatable portions 51 are brought to continuously change between the first non-expanded state 51a and the first expanded state 51b in a specific sequence and thereby produce a massage effect on the patient lying in the lying space 53 to improve the patient's blood circulation.

As shown, in the illustrated first embodiment, the circuit board 18 first specifies the first control valve 12 to block the air blower 161 from the first air delivery lines 201. Therefore, no air is further supplied from the air blower 161 to the first air delivery lines 201, and the four pieces of first support air cells 511 gradually change from the first expanded state 51b into the first non-expanded state 51a.

When the four pieces of first support air cells 511 gradually change from the first expanded state 51b into the first non-expanded state 51a, the circuit board 18 will further instruct the first control valve 12 to block the air blower 161 from the second air delivery lines 202, so that the air blower 161 stops supplying air to the second air delivery lines 202, bringing the four pieces of second support air cells 512 to gradually change from the first expanded state 51b into the first non-expanded state 51a.

When the first support air cells 511 have changed into the first non-expanded state 51a, the circuit board 18 will instruct the first control valve 12 to fluidly connect the air blower 161 to the first air delivery lines 201 while blocks the air blower 161 from the third air delivery lines 203. Therefore, the four pieces of first support air cells 511 are brought to gradually change from the first non-expanded state 51a into the first expanded state 51b, and the four pieces of third support air cells 513 are brought to gradually change from the first expanded state 51b into the first non-expanded state 51a. With these arrangements, through control of the first control valve 12, the air blower 161 can be selectively fluidly connected to some of the first, the second and the third air delivery line 201, 202, 203, enabling the air mattress 50 to present a wave-like motion on its surface, which produces a massage effect on the patient lying in the lying space 53 to improve the patient's blood circulation.

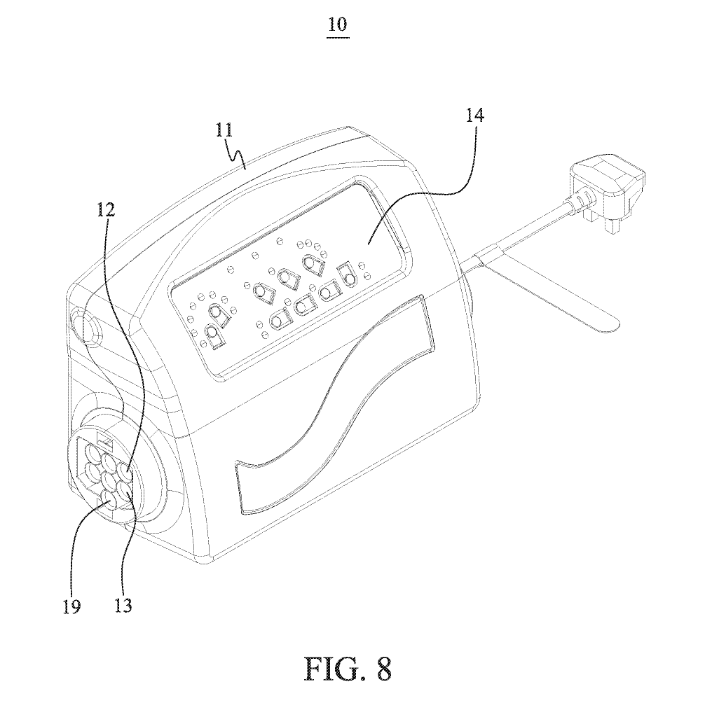

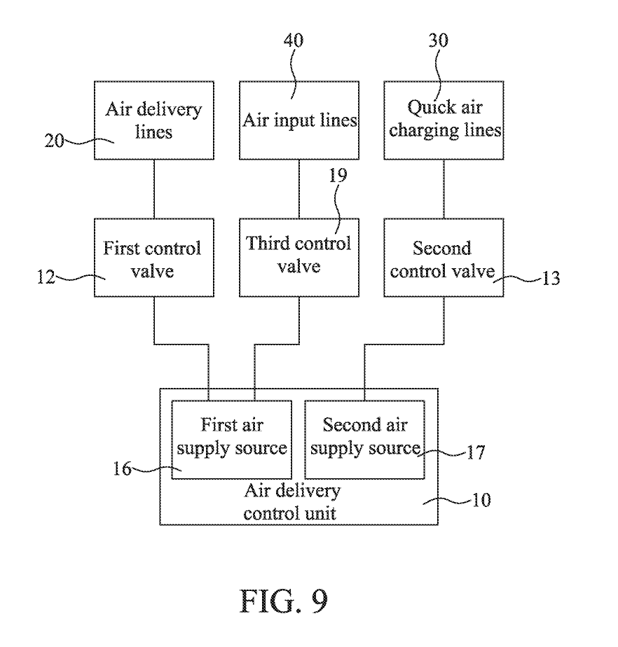

FIG. 8 is a perspective view of the air delivery control unit 10 according to a second embodiment of the present invention. Since the structural arrangements of the air delivery control unit 10, the air delivery lines 20 and the quick air charging lines 30 in the second embodiment are generally similar to those in the first embodiment, they are not repeatedly described herein. The second embodiment is different from the first embodiment only in that the air input lines 40 thereof are connected to the first air supply source 16 in the air delivery control unit 10 via a third control valve 19 provided on the housing 11, as shown in FIG. 9.

In the second embodiment, with the air input lines 40 being connected to the first air supply source 16 in the air delivery control unit 10 via the third control valve 19, air can be directly supplied from the first air supply source 16 to the air input lines 40 for inflating the second inflatable portions 52 of the air mattress 50, bringing the second inflatable portions 52 to change from the second non-expanded state 52a into the second expanded state 52b. With this arrangement, air can always be supplied from the first air supply source 16 to the second inflatable portions 52 of the air mattress 50 even if the first air supply source 16 does not supply air to the air delivery lines 20, so that the second inflatable portions 52 can continuously maintain the second expanded state 52b.

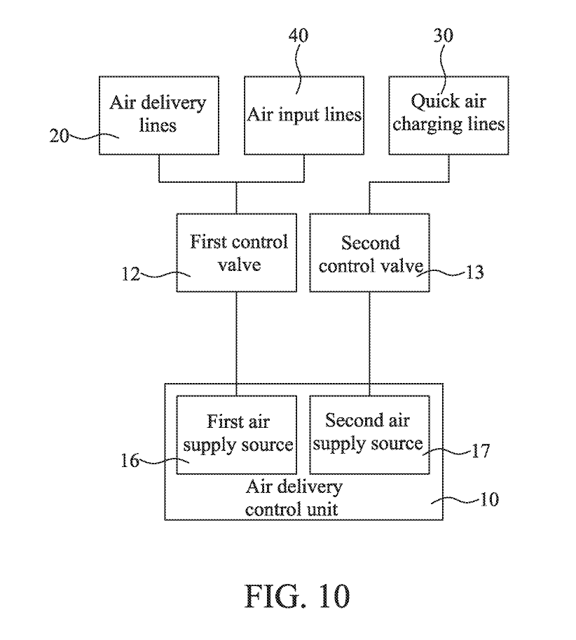

However, it is understood the connection of the air input lines 40 to the first air supply source 16 via the third control valve 19 is only illustrative and not intended to limit the present invention in any way. For example, in another operable embodiment as shown in FIG. 10, the air input lines 40 can also be directly connected to the first air supply source 16 via the first control valve 12.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A quick inflation system for using with an air mattress, the air mattress including a plurality of first inflatable portions to be inflated and deflated intermittently and at least one second inflatable portion to be always inflated; the quick inflation system comprising:
a first air supply source having a first control valve;
a second air supply source;
a plurality of air delivery lines being connected at respective one end to the first control valve and at respective another end to one of the first inflatable portions; and each of the air delivery lines having a connecting line extended therefrom;
a plurality of quick air charging lines being connected at respective one end to the second air supply source and at respectively another end to one of the air delivery lines; and
at least one air input line being simultaneously connected to all the connecting lines and the at least one second inflatable portion of the air mattress;
wherein, through control of the first control valve, the first air supply source can be selectively blocked from some of the air delivery lines or fluidly connected to each of the air delivery lines.

2. The quick inflation system for air mattress as claimed in claim 1, wherein the quick air charging lines are connected to the second air supply source via a second control valve; and the second air supply source can, through control of the second control valve, be selectively blocked from all the quick air charging lines or fluidly connected to each of the quick air charging lines.

3. The quick inflation system for air mattress as claimed in claim 1, wherein the first air supply source is fluidly connected to the air delivery lines through control of the first control valve and supplies air to the air delivery lines, such that a part of the supplied air directly flows into the first inflatable portions of the air mattress for the first inflatable portions to change from a first non-expanded state, in which the first inflatable portions are not fully inflated, into a first expanded state, in which the first inflatable portions are fully inflated, and the other part of the supplied air flows through the connecting lines into the air input line for the second inflatable portion of the air mattress to change from a second non-expanded state, in which the second inflatable portion is not fully inflated, into a second expanded state, in which the second inflatable portion is fully inflated; and wherein the second air supply source supplies air to the quick air charging lines, such that the supplied air also flows into the air delivery lines to quicken the change of the first inflatable portions of the air mattress from the first non-expanded state into the first expanded state.

4. The quick inflation system for air mattress as claimed in claim 3, wherein, when all the first inflatable portions have changed into the first expanded state, the second air supply source stops supplying air to all the quick air charging lines and the first air supply source is, through control of the first control valve, fluidly connected to only a part of the air delivery lines, bringing some of the first inflatable portions to change between the first non-expanded state and the first expanded state.

5. The quick inflation system for air mattress as claimed in claim 3, wherein, when all the first inflatable portions have changed into the first expanded state, the second air supply source stops supplying air to all the quick air charging lines and the first air supply source is, through control of the first control valve, fluidly connected to different ones of the air delivery lines in a specific sequence, so that some of the first inflatable portions are changed from the first non-expanded state into the first expanded state, while others are changed from the first expanded state into the first non-expanded state.

6. The quick inflation system for air mattress as claimed in claim 1, wherein the air input line is connected to the first control valve of the first air supply source.

7. The quick inflation system for air mattress as claimed in claim 1, wherein the first air supply source further has a third control valve, and the air input line being connected to the third control valve.

8. The quick inflation system for air mattress as claimed in claim 3, wherein the connecting lines respectively have a first air check unit provided thereon, so that air in the connecting lines can flow in only one direction from the air delivery lines to the air input line; whereby the second inflatable portion of the air mattress can continuously maintain the second expanded state even if the first air supply source is fluidly connected to different ones of the air delivery lines in a specific sequence.

9. The quick inflation system for air mattress as claimed in claim 1, wherein the quick air charging lines respectively have a second air check unit provided thereon, so that air in the quick air charging lines can flow in only one direction from the quick air charging lines to the air delivery lines.

10. The quick inflation system for air mattress as claimed in claim 1, wherein the air delivery lines respectively have a first coupling section and a second coupling section located at two opposite ends thereof; the first coupling sections being respectively connected to the first control valve, and the second coupling sections being respectively connected to one of the quick air charging lines.
